(19) United States
(12) Patent Application Publication
(10) Pub. No.: US 2016/0162045 A1
(43) Pub. Date: Jun. 9, 2016

(54) PAINT BRUSH CAPACITIVE STYLUS TIP

(71) Applicant: CIRQUE CORPORATION, Salt Lake City, UT (US)

(72) Inventor: Paul Vincent, Kaysville, UT (US)

(21) Appl. No.: 14/964,167

(22) Filed: Dec. 9, 2015

Related U.S. Application Data
(60) Provisional application No. 62/089,593, filed on Dec. 9, 2014.

(51) Int. Cl. G06F 3/038; G06F 3/0354

(52) U.S. Cl. CPC G06F 3/0383; G06F 3/03545

(57) ABSTRACT

A system and method for using changes in capacitance between two or more conductive elements to detect a magnitude of stylus tip pressure, degree of rotation and movement, using a change in capacitance between alternative layers of conducting and insulating materials that are disposed in an elastomeric stylus tip and deformed to cause a change in capacitance, using a conductive element that is disposed in the stylus tip and passing into the stylus body and then measuring a deflection of the conductive element from a centered position when the stylus tip is deformed by using capacitive sensing electrodes disposed on the inner wall of the stylus body or a single proximity sensing capacitive sensor disposed perpendicular to a length of the conductive element.

### BACKGROUND

### Description of Related Art

There are different stylus pens in the prior art that utilize various technologies to provide digital input. Recent advances in stylus technology have produced styli that look and feel like a pen or a paint brush that may produce information regarding pressure on a stylus pen tip. Some styli contain no batteries or magnets. These performance styli take advantage of electromagnetic resonance technology in which radio waves are sent to the stylus and are returned for position analysis. In some applications, a grid of electrodes is placed below a display screen which alternates between transmit and receive modes about every 20 microseconds.

The electro-magnetic signal from the grid of electrodes stimulates oscillation in a coil-and-capacitor resonant circuit in the pen. The resonant circuit in the pen's tip supplies the power and serves as transmitter too. The received signal goes through a modulator to a chip. The information of the pressure sensor (capacity) and of the side switch may go to a circuit first. The Tool ID is then added and both are sent back to the modulator which in turn sends a signal to the resonant circuit in the stylus tip. The tablet picks up the information in the pen's tip in order to determine position and other information such as pressure and Tool ID.

A simple analogy for this patented technology is that of a piano tuner using a tuning fork to tune a piano. As the tuning fork is brought into proximity of the appropriate vibrating piano string (if the fork is of the same frequency) it will begin to borrow energy from the vibrating sting and resonate, generating a tone. In much the same way, the pen comes close to the tablet surface, it begins to resonate, generating its own frequency back to the tablet. When it hears the pen, it tracks the pen's location with unprecedented accuracy. The tablet then sends location, pressure and tilt information to the computer along with a signal indicating whether the pen point or the eraser is being used.

These advanced styli have the unfortunate characteristic of being very expensive and complicated. These market forces have prevented wide scale adoption of the more sophisticated capacitive and inductive stylus solutions. Nevertheless, it would be an advantage over the state of the art to be able to provide a stylus with a brush or pen tip that could provide information such as the amount of pressure applied to tablet by the pen tip, the angle the pen tip is tilted, and the orientation of the pen around its long axis all while providing the familiar feel of a pliable brush tip.

It is also useful to examine capacitive sensing technology that may be used with a capacitive stylus to provide the functions of the present invention. Accordingly, it is useful to examine the underlying technology to better understand how any capacitance sensitive touchpad can be modified to work with the present invention.

The CIRQUE® Corporation touchpad is a mutual capacitance-sensing device and an example is illustrated as a block diagram in FIG. 1. In this touchpad 10, a grid of X (12) and Y (14) electrodes and a sense electrode 16 is used to define the touch-sensitive area 18 of the touchpad. Typically, the touchpad 10 is a rectangular grid of approximately 16 by 12 electrodes, or 8 by 6 electrodes when there are space constraints. Interlaced with these X (12) and Y (14) (or row and column) electrodes is a single sense electrode 16. All position measurements are made through the sense electrode 16.

The CIRQUE® Corporation touchpad 10 measures an imbalance in electrical charge on the sense line 16. When no pointing object is on or in proximity to the touchpad 10, the touchpad circuitry 20 is in a balanced state, and there is no charge imbalance on the sense line 16. When a pointing object creates imbalance because of capacitive coupling when the object approaches or touches a touch surface (the sensing area 18 of the touchpad 10), a change in capacitance occurs on the electrodes 12, 14. What is measured is the change in capacitance, but not the absolute capacitance value on the electrodes 12, 14. The touchpad 10 determines the change in capacitance by measuring the amount of charge that must be injected onto the sense line 16 to reestablish or regain balance of charge on the sense line.

The system above is utilized to determine the position of a finger on or in proximity to a touchpad 10 as follows. This example describes row electrodes 12, and is repeated in the same manner for the column electrodes 14. The values obtained from the row and column electrode measurements determine an intersection which is the centroid of the pointing object on or in proximity to the touchpad 10.

In the first step, a first set of row electrodes 12 are driven with a first signal from P, N generator 22, and a different but adjacent second set of row electrodes are driven with a second signal from the P, N generator. The touchpad circuitry 20 obtains a value from the sense line 16 using a mutual capacitance measuring device 26 that indicates which row electrode is closest to the pointing object. However, the touchpad circuitry 20 under the control of some microcontroller 28 cannot yet determine on which side of the row electrode the pointing object is located, nor can the touchpad circuitry 20 determine just how far the pointing object is located away from the electrode. Thus, the system shifts by one electrode the group of electrodes 12 to be driven. In other words, the electrode on one side of the group is added, while the electrode on the opposite side of the group is no longer driven. The new group is then driven by the P, N generator 22 and a second measurement of the sense line 16 is taken.

From these two measurements, it is possible to determine on which side of the row electrode the pointing object is located, and how far away. Pointing object position determination is then performed by using an equation that compares the magnitude of the two signals measured.

The sensitivity or resolution of the CIRQUE® Corporation touchpad is much higher than the 16 by 12 grid of row and column electrodes implies. The resolution is typically on the order of 960 counts per inch, or greater. The exact resolution is determined by the sensitivity of the components, the spacing between the electrodes 12, 14 on the same rows and columns, and other factors that are not material to the present invention. The process above is repeated for the Y or column electrodes 14 using a P, N generator 24.

It is to be understood that the following description is only exemplary of the principles of the present invention, and should not be viewed as narrowing the claims which follow. It should also be understood that the terms “touchpad”, “touch sensor”, “touchscreen”, “touch input device”, “touch sensitive device” and “proximity sensing capacitive sensor” may be used interchangeably throughout this document.

### BRIEF SUMMARY

The present invention is a system and method for using changes in capacitance between two or more conductive elements to detect a magnitude of stylus tip pressure, degree of rotation and movement, using a change in capacitance between alternate layers of conducting and insulating materials that are disposed in an elastomeric stylus tip and deformed to cause a change in capacitance, using a conductive element that is disposed in the stylus tip and passing into the stylus body and then measuring a deflection of the conductive element from a centered position when the stylus tip is deformed by using capacitive sensing electrodes disposed on the inner wall of the stylus body or a single proximity sensing capacitive sensor disposed perpendicular to a length of the conductive element, or using touch stick technology that may determine the direction from which pressure is being applied, and the amount of pressure that is being applied.

These and other embodiments of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a block diagram of the components of a capacitance-sensitive touchpad as made by CIRQUE® Corporation and which can be operated in accordance with the principles of the present invention.

FIG. 2 is a profile view of a first embodiment of the invention using an elastomeric stylus tip having alternative layers of conducting and insulating materials.

FIG. 3 is a perspective view of some of the shapes that elastomeric materials may form.

FIG. 4 is a block diagram showing a stylus, a touch sensor and possible locations for the capacitance detection circuit.

FIG. 5 is a cut-away profile view of a second embodiment showing a conductive element that is disposed in the stylus tip and into the stylus body and then measuring a deflection of the conductive element from a centered position when the stylus tip is deformed by using capacitive sensing electrodes disposed on or in the inner wall of the stylus body.

FIG. 6 is an illustration of one method of determining position of the conductive element when there are four electrodes.

FIG. 7 is a cut-away profile view of a third embodiment showing a conductive element that is disposed in the stylus tip and into the stylus body and then measuring a deflection of the conductive element from a centered position when the stylus tip is deformed by using a single proximity sensing capacitive sensor disposed perpendicular to the conductive element.

FIG. 8 is a circuit diagram of touch stick circuitry that may be adapted to function for the present invention.

FIG. 9 is a block diagram of the circuitry of an embodiment of touch stick circuitry that is more resistance to noise.

FIG. 10A is a conceptual circuit diagram that is representative of touchpad circuitry when measuring charge transfer from electrodes of a touchpad.

FIG. 10B is a conceptual circuit diagram that is representative of touchpad circuitry when measuring charge transfer from voltage divider circuitry of a touch stick.

FIG. 11 is a detailed circuit diagram of a touch stick circuit embodiment that is modified to include an external resistor that is used when making a measurement in the Z axis, and the measurement points for making measurements in the X, Y and Z axes.

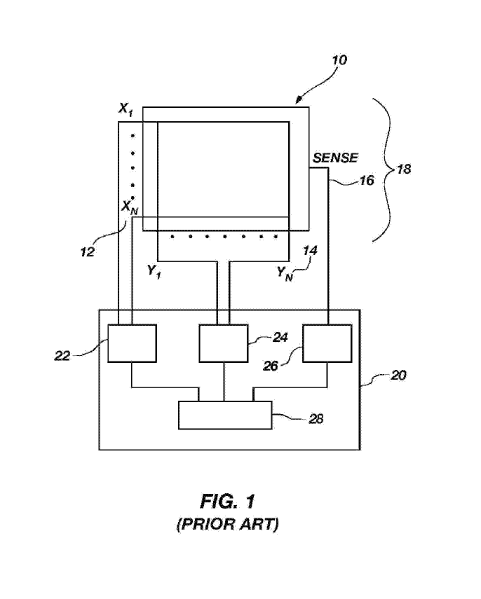

### DETAILED DESCRIPTION

Reference will now be made to the drawings in which the various embodiments of the present invention will be given numerical designations and in which the embodiments will be discussed so as to enable one skilled in the art to make and use the invention. It is to be understood that the following description illustrates embodiments of the present invention, and should not be viewed as narrowing the claims which follow.

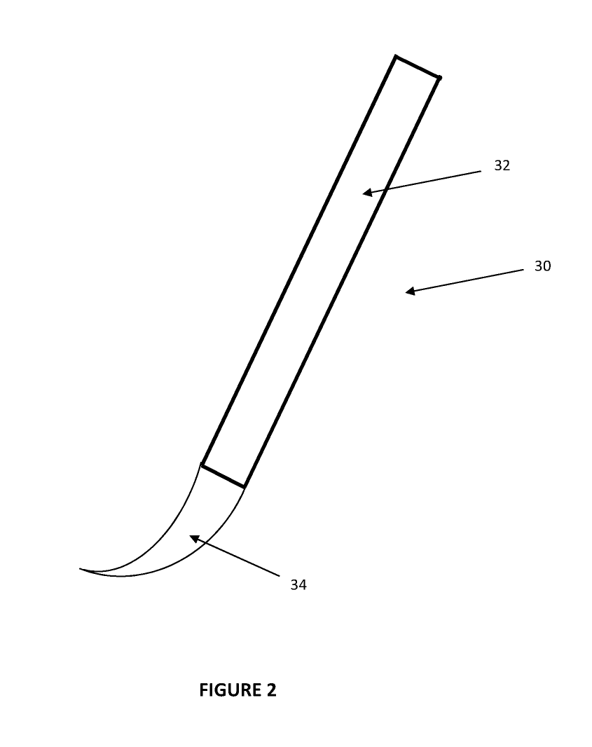

A first embodiment of the present invention is shown in FIG. 2. FIG. 2 shows a pen or stylus 30 comprised of a stylus body 32 and a brush stylus tip 34. The brush stylus tip 34 may be a capacitive paint brush-type of tip and may be made of a pliable or flexible material such as an elastomeric material. Any flexible material may be used that provides the same features and characteristics of this capacitive brush stylus tip 34. The brush stylus tip 34 may also be comprised of a conductive material on and/or inside the elastomeric material.

A brush stylus tip 34 that operates as a brush tip may be distinguished from other stylus tips in that a brush stylus tip may be characterized in having a tip that may have a wider range of variance in pressure applied, or in the amount of surface area that can be made to make contact with a touch sensor in order to bring a greater degree of control over the type of contact that is made by a stylus. In other words, just as a paint brush can have a light touch or heavy touch, a wide stroke or a thin stroke, the brush stylus tip 34 may try to emulate this degree of control over the nature of the stroke being made by the stylus 30.

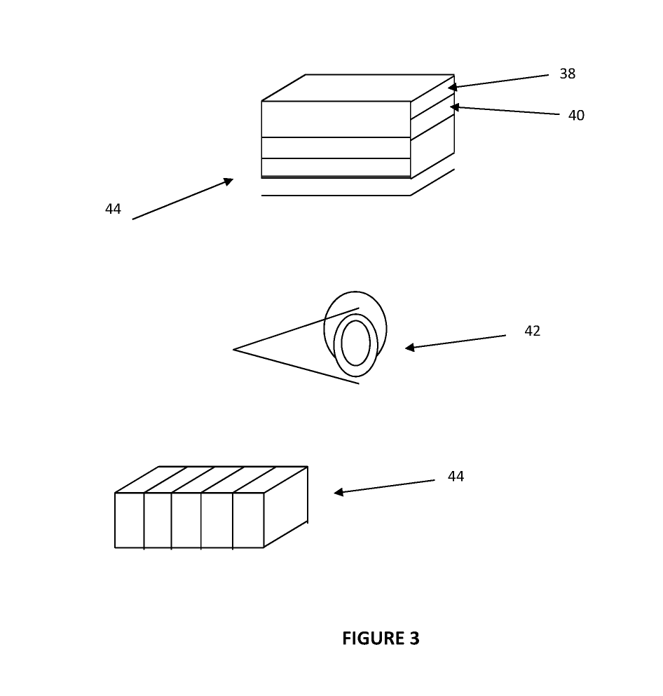

In this first embodiment, the capacitive brush stylus tip 34 may be comprised of an elastomer having alternating conducting and insulating layers within the elastomer material as shown in FIG. 3. The alternative conductive layers 38 and insulating layers 40 may be formed in a cone shape 42, as a planar shape 44 or any shape that allows for alternative conducting and insulating layers to bend with respect to each other.

When the alternating conducting layers 38 and insulating layers 40 bend with respect to each other, the capacitance changes between the conductive layers. A capacitance detection circuit may be used to detect this change in capacitance. The touch capacitance circuit of CIRQUE Corporation® may be used to detect this change in capacitance. Alternatively, any other circuit may also be used that is capable of detecting the change in capacitance.

One or more electrodes may be disposed within the stylus body 32 and which are in contact with the capacitive layers, 38, 40 in the capacitive brush stylus tip 34. The one or more electrodes may transmit electrical signals from the conductive layers 38, 40 to a capacitance detection circuit. The capacitance detection circuit may be used to detect the change in capacitance between the at least two conductive layers, 38, 40 in the capacitive brush stylus tip 34.

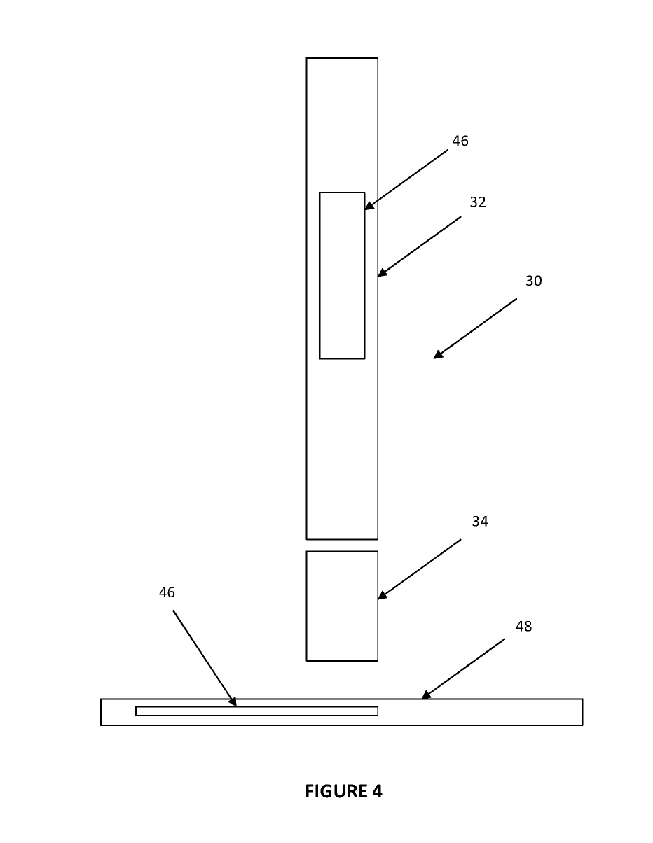

As shown in FIG. 4, the capacitance detection circuit 46 may be disposed within a touch sensor 48 or within the stylus body 32. The stylus 30 may be associated and used with the touch sensor 48, or it may be separate.

A sense input on the capacitance detection circuit 46 may be coupled to one or more of the electrodes coupled to the at least two conducting layers 38, 40 of the capacitive brush stylus tip 34.

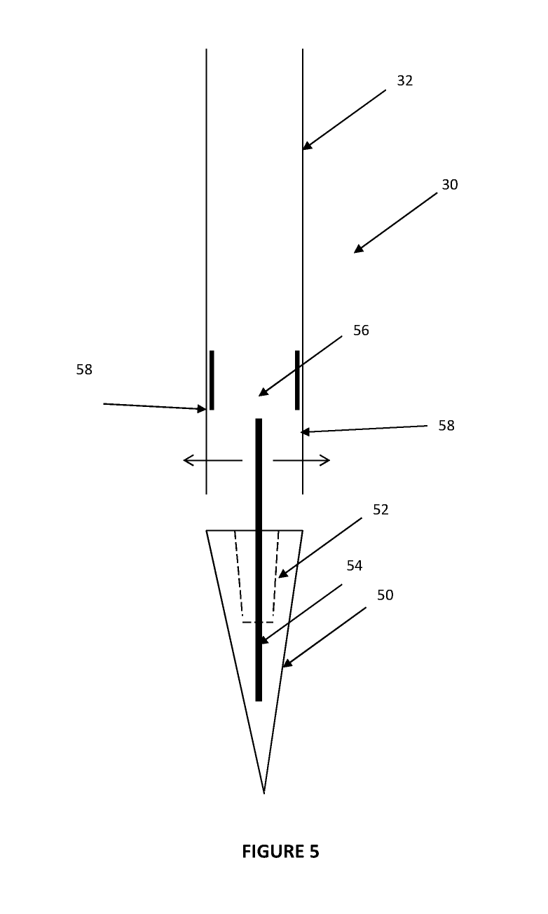

A second embodiment of the present invention is shown in FIG. 5. FIG. 5 shows a pen or stylus 30 comprised of a stylus body 32 and an alternative capacitive brush stylus tip 50. The capacitive brush stylus tip 50 may be a capacitive brush-type of tip and being made of a pliable or flexible material such as an elastomeric material. Any flexible material may be used that provides the same features and characteristics of this capacitive brush stylus tip 50.

FIG. 5 illustrates the physical configuration of some of the components of the second embodiment and shows that a portion of the capacitive brush stylus tip 50 may contain a hollow or cavity 52 therein. The cavity 52 enables a movement axis of a conductive element 54 to be closer to the end of the capacitive brush stylus tip 50. However, this feature is not required and does not have to be present in the capacitive brush stylus tip 50 for the embodiment to function.

The conductive element 54 may be embedded into the capacitive brush stylus tip 50 for attachment or it may be the tip itself. It should be understood that as the elastomer of the capacitive brush stylus tip 50 is deformed that the conductive element 54 may bend in the same direction within the cavity 52. The conductive element 54 may be made of a length that is sufficient to allow it to extend partially into the stylus body 32 as shown. The movement of the free end 56 of the conductive element 54 that is within the stylus body 32 may be measured using capacitance sensing technology. For example, electrodes 58 may be used to determine the relative position of the conductive element 54 as it moves as indicated by the arrows.

In the alternative where the conductive element 54 is the tip itself, the tip may be formed such that a portion of the tip extends in a manner that is similar to the conductive element 54 disposed within the tip in FIG. 5. The tip deflection may cause a measurable difference in either capacitance or resistance.

In the second embodiment above, the capacitive sensing technology may be comprised of the capacitance sensing electrodes 58 disposed on an inner wall of the stylus body 32. The plurality of capacitance sensing electrodes 58 may be positioned in any manner that enables rapid calculation of position of the conductive element 54 within the stylus body 32.

For example, by measuring a capacitance between the conductive element 54 and each of the plurality of capacitance sensing electrodes 58, it may be possible to calculate the position based on the ratio of the strength of the capacitance as measured by each of the capacitance sensing electrodes 58 as is known to those skilled in the art. Thus, if the conductive element 54 is centered within the stylus body when the stylus tip is at rest, then the capacitance signal on each of the plurality of capacitance sensing electrodes 58 may be the same. Any deflection of the conductive element 54 from a centered position within the stylus body 32 will change the capacitance value which is used to determine the position of the conductive element. The conductive element 54 may be centered in order to maximize the amount of degree of deflection of the conductive element that can be measured within the stylus body 32.

The capacitance between the conductive element 54 and each of the plurality of capacitance sensing electrodes 58 may be determined using the same capacitance detection circuit 46 that is used in the first embodiment.

In this second embodiment, a total of four capacitance sensing electrodes 58 may be used to determine the position of the conductive element 54. However, it should be understood that the precise position and number of the plurality of capacitance sensing electrodes 58 may be modified as desired and should not be considered as limiting the invention.

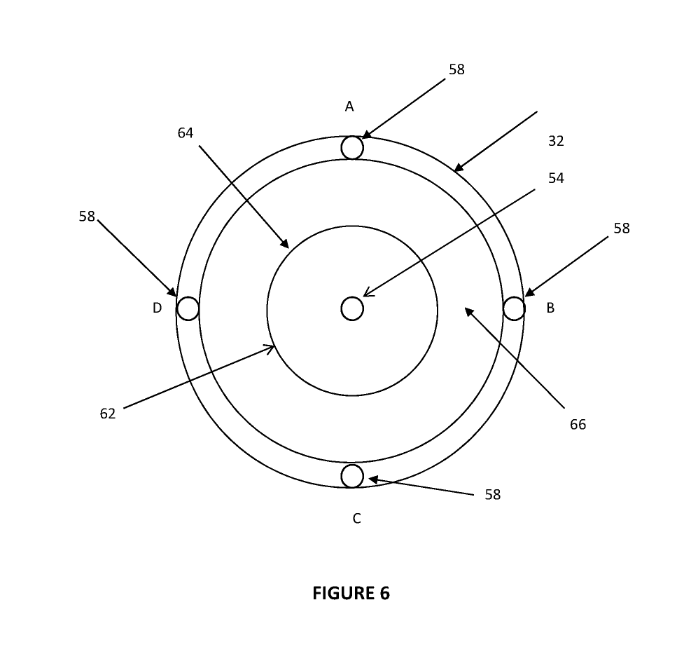

A method of using a ratio of the strength of capacitive signals from four capacitance sensing electrodes 58 in the second embodiment may be understood as follows. FIG. 6 is a cut-away view of the stylus body 32. The figure shows the position of the four capacitive electrodes 58 that are disposed at equidistant positions on an inner wall of the stylus body 32.

The circle 62 may represent the position of the conductive 54 if it is deflected halfway between a centered position and a maximum position. The conductive element 54 is shown as centered within the stylus body 32.

At the position marked as position 64, the strength of the capacitive signal between electrodes A and D would be equal and half the signal strength that they would be at the maximum deflected position. This provides a magnitude of deflection. At position 66, assuming that the conductive element 54 is on a line directly between a center of the stylus body 2 and the electrode B, then a measured capacitive value is going to be equal between capacitance sensing electrodes A and C, at a value of 75% of maximum for electrode B, and be decreasing for electrode D. It is a matter of geometry and ratios that is known to those skilled in the art to determine the position of the free end 56 of the conductive element 54.

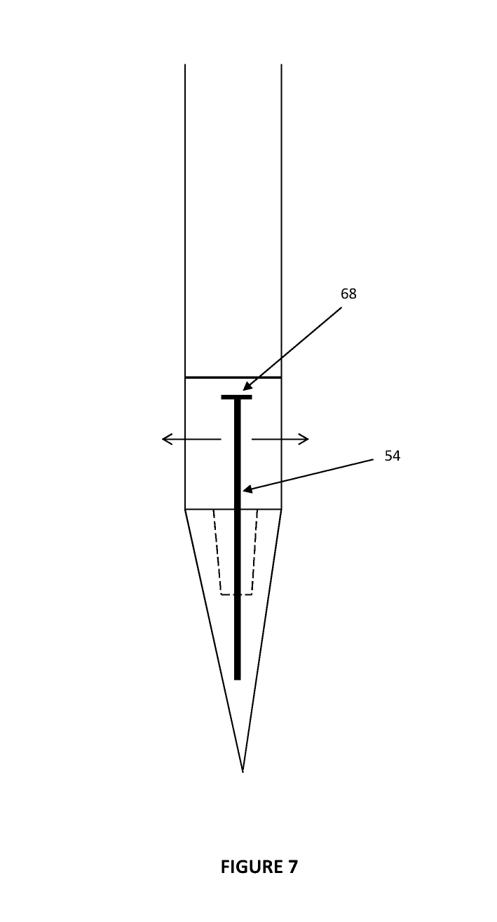

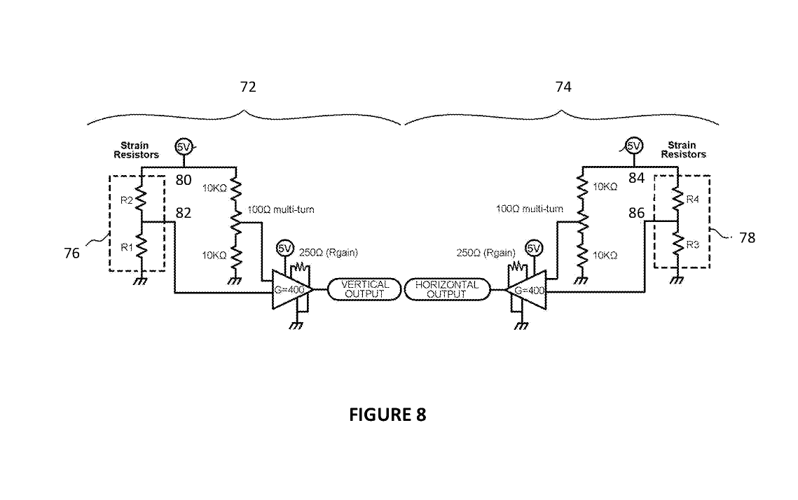

FIG. 7 is provided as a third embodiment of the present invention. FIG. 7 may modify the second embodiment by adding a conductive button or pill 68 to the free end 56 of the conductive element 54. The conductive pill 68 may increase a signal from the conductive element 54. The capacitive signal from the conductive element 54 may be detected and measured by a proximity sensitive capacitive sensor. The proximity sensitive capacitive sensor may be disposed so that it is co-planar with a diameter of the stylus body 32 and perpendicular to the axis of the stylus body. The conductive element 54 does not have to touch the proximity sensitive capacitive sensor in order for a position to be detected. The proximity sensitive capacitive sensor is positioned such that the free end 56 of the conductive element 54 is free to move until touching an inner wall of the stylus body 32 if that is possible at maximum deflection.

The conductive pill 68 may be comprised of any suitable material that is detectable by a proximity sensing capacitive sensor. For example, the conductive pill may be a carbon pill or a conductive washer.

Depending upon the amount of deflective of the conductive element 54 from a centered position within the stylus body 32, the degree of deflection of the stylus tip may be determined. The degree of deflection of the capacitive brush stylus tip 50 may be determined using calculations or by creating a chart of actual measured deflection and corresponding position signals from the proximity sensitive capacitive sensor.

The touch capacitance circuit of CIRQUE Corporation® may be used to detect this change in capacitance. Any other circuit may also be used that is capable of detecting the change in capacitance. The capacitance detection circuit 46 may be disposed within a touch sensor 48 or within the stylus body 32. The stylus 30 may be associated and used with the touch sensor 48, or it may be separate.

It should be understood that the proximity sensitive capacitive sensor may be a proximity and touch sensor as provided by CIRQUE Corporation®.

This invention may enable detecting capacitive brush stylus tip 50 pressure magnitude and direction necessary to emulate an actual pen or brush input to a digitized drawing system. Variable magnitude of pressure may allow the capacitive brush stylus tip 50 to vary line thickness, fill (solid versus bristled), width, proximity, hover, etc. Variable direction may allow the stylus tip to vary how the line thickness and fill emulate the actual touch surface area for applications such as calligraphy, or to provide different types of brush strokes.

Regarding magnitude of deflection, this value may be determined using all three embodiments of the invention using the magnitude of the signal in the first embodiment, and the position of the free end 56 of the conductive element 54 in the second and third embodiments. Rotation of the capacitive brush stylus tip 50 may also be determined using all three embodiments because this may be determined from the position information above. Finally, movement of the stylus 30 may also be determined if the stylus is moving across the surface of a touch sensor 48.

In another embodiment of the invention, touch stick technology may be adapted for use in the stylus 30 by replacing the stylus tip with a touch stick stylus tip. In a first embodiment of touch stick technology, touch stick circuitry may be divided into two separate but identical circuits 72 and 74. A voltage divider 76, 78 may be created for the vertical axis circuit 72 and horizontal axis circuit 74 of a touch stick stylus tip. A 5V source may be provided for each voltage divider 76, 78. It is important to notice that signals 80, 82 and 84, 86 need to be amplified. Using the values shown in these circuits, the gain from the amplifier of the signals 80, 82 and 84, 86 may be approximately 400. As a result of this significant amount of signal amplification, the touch stick circuits are very sensitive to noise.

Another source of error in a signal obtained from touch stick circuitry is from offsets in the touch stick voltage divider, as well as drift is resistor values over usage duration.

It should be noted that the touch stick circuits 72, 74 may be modified and still perform the same function. But it is generally the case that touch stick circuits may be susceptible to noise because of the high gain used to boost the signals that are obtained.

It is useful to think of touch stick circuitry as essentially performing the function of a strain gauge. The pressure applied to the touch stick is measured so that an associated object, such as a computer cursor, can be moved at a certain rate as determined by the amount of pressure being applied to the touch stick.

In a second touch stick embodiment that takes advantage of capacitance sensing technology of the first embodiments, it is possible to measure the amount of force that is being applied to the touch stick using the signals that are generated by a voltage divider, but without amplifying noise that is generally going to be present in the signals.

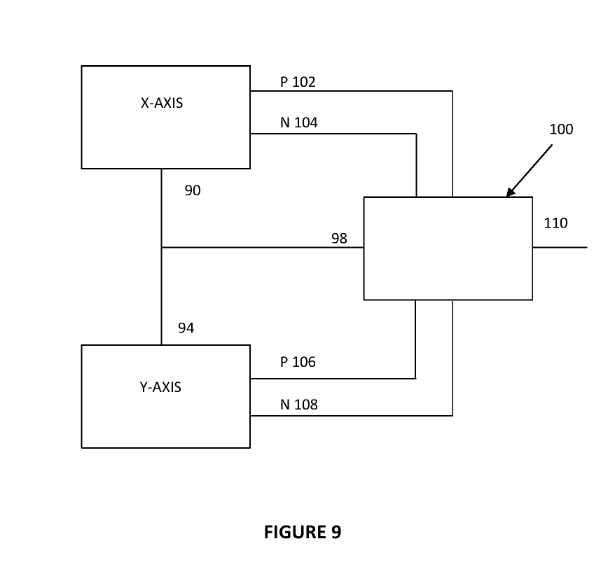

FIG. 9 is a block diagram, wherein a signal 90 from an X-axis voltage divider circuit 92 is sent to a sense line input 98 of a capacitance sensitive touchpad circuit 100, and a signal 94 from a Y-axis voltage divider circuit 96 is sent to the sense line input 98 of the capacitance sensitive touchpad circuit 100. P and N signals 102, 104, 106 and 108 are also taken from the X-axis and Y-axis voltage divider circuits 92 and 96. An output signal 102 from the touchpad circuit 100 is the proportional value of the capacitive coupling between the sense electrodes and the P and N electrodes. A positive value indicates greater coupling between the P electrodes and the sense electrode, and a negative result indicates greater coupling between the N electrodes and the sense electrode.

From the output signal 110, it may be possible to determine the amount of force being applied to a strain device, such as a stylus tip, in both the X and Y axes.

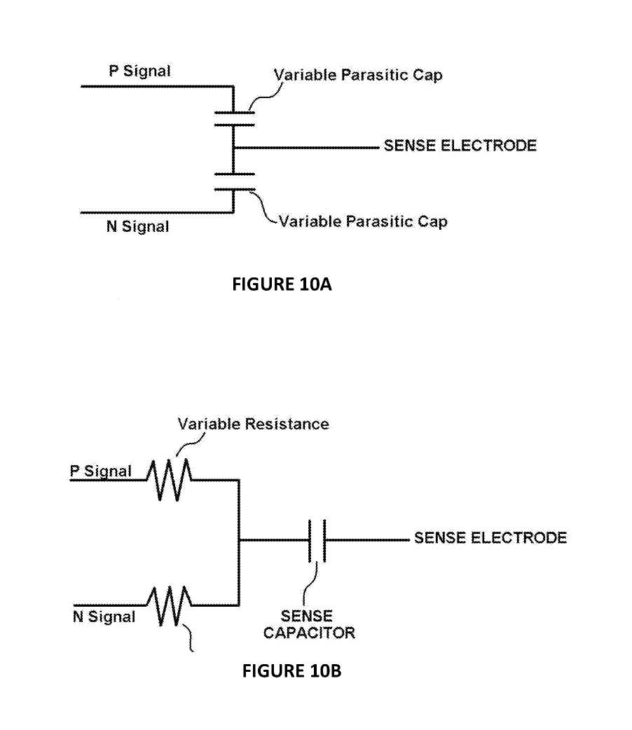

It should be understood that the measurement relies on measuring the charge transfer measured by the sense electrode when P and N signals are toggled. Thus beginning with FIG. 10A, this figure is a schematic diagram that describes the nature of the circuit but not the actual circuit that exists when the touchpad circuitry is operating with a touchpad. Thus conceptually, in the touchpad measurement method, the P and N signals are coupled to the sense electrode by variable parasitic capacitors whose capacitive values are modulated by user modulation of the capacitor dielectrics. In other words, the presence of a finger enables the capacitive coupling between the P and N signals and the sense line.

When user modulation of the parasitic capacitors results in greater capacitive coupling between the P signal and the sense electrode, the resulting signal on the sense electrode is more positive. Thus, the finger is nearer to an electrode with a P signal. Likewise, when user modulation of the parasitic capacitors results in greater capacitive coupling between the N signal and the sense electrode, the resulting signal on the sense electrode is more negative.

In contrast, the conceptual circuit that is created when the touch stick is being used may be different. FIG. 10B is a circuit diagram that shows that the touch stick creates a user modulated voltage divider between the P and N signals. In other words, pushing on a touch stick stylus tip changes the resistance being measured in the X and Y voltage dividers. The output of the voltage dividers is then capacitively coupled to the sense electrode via a capacitive component (sense capacitor) having a static value.

For example, consider a touch stick stylus tip that has a P signal in a left direction and an N signal in a right direction. If the touch stick stylus tip is pushed to the left, the resistance connected to the P signal is less than the resistance connected to the N signal, and the resulting signal on the sense electrode will be more positive. The system then knows that the user is pushing the touch stick stylus tip to the left. The situation is the same when the touch stick stylus tip is pushed towards the right. The result will be more negative on the sense electrode.

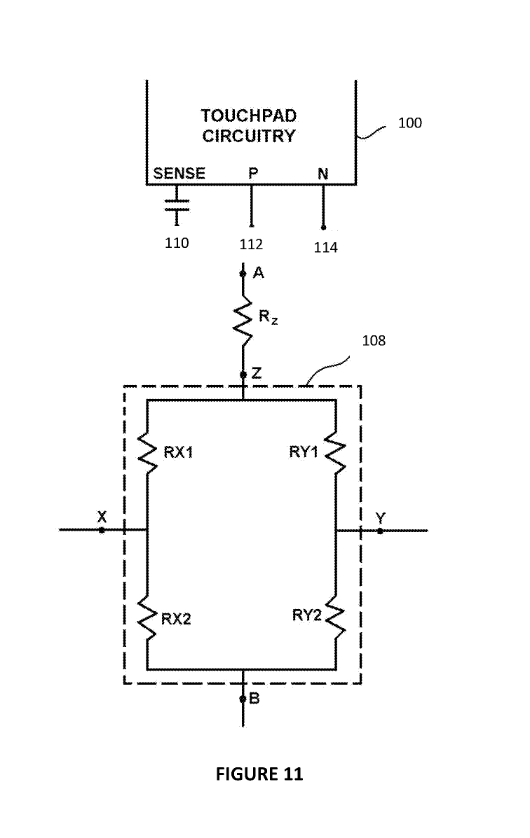

The circuit of a touch stick stylus tip coupled to touchpad circuitry is now described in FIG. 11 to show more detail of the circuitry of FIG. 9, but in a schematic diagram.

In FIG. 11, what is shown is the voltage divider circuitry within dashed line 108 that is already part of existing touch stick circuitry 100. Signal measurements are taken from any one of five different locations on the touch stick circuitry 100, depending on what value is being determined. To assist in understanding and summarizing the measurements, Table 1 is provided below.

TABLE 1

| | X Measurement | Y Measurement | Z Measurement |
|---|---|---|---|
| X | Sense | No Connection | No Connection |
| Y | No Connection | Sense | No Connection |
| Z | P Signal | P Signal | Sense |
| A | No Connection | No Connection | P Signal |
| B | N Signal | N Signal | N Signal |

An X measurement is a measurement that provides information regarding how hard the touch stick stylus tip is being pushed relative to an X axis. In other words, the measurement determines if there is an X axis component to the force being applied to the touch stick stylus tip. Similarly, a Y measurement is a measurement that provides information regarding how hard the touch stick stylus tip is being pushed relative to a Y axis. Thus, this measurement determines if there is a Y axis component to the force being applied to the touch stick stylus tip. It should be apparent that a force may be applied in only one axis, but is more likely to be applied in at least two axes at the same time.

According to Table 1, X is coupled to the sense 110, Y has no connection, Z has is coupled to P 112, A has no connection, and B is coupled to N 114. The connections for making a Y measurement should now be apparent from Table 1.

It should also be apparent from Table 1 that a Z measurement is also possible. For example, if RZ is, for example, made equal to the resistance of the stylus tip resistors, or in other words, the combination of RX1 in series with RX2 in parallel with RY1 in series with RY2, then a force applied on the stylus tip would result in a decrease in the resistance of the stylus tip resistors, and the circuit is again a voltage divider at location Z.

It should now be apparent that using touchpad control circuitry 100 to receive and measure signals from the touch stick stylus tip is performed without having to amplify any signals coming from the touch stick stylus tip resistors. Accordingly, the system is much less sensitive to noise on the signals. Furthermore, the touchpad circuitry 100 does not have to be altered to perform the function of measuring charge transfer.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. It is the express intention of the applicant not to invoke 35 U.S.C. §112, paragraph 6 for any limitations of any of the claims herein, except for those in which the claim expressly uses the words ‘means for’ together with an associated function.

What is claimed is:

1. A system for detecting a magnitude of pressure on a capacitive stylus tip, said system comprised of:
a stylus body;
a capacitive stylus tip coupled to a working end of the stylus body, the capacitive stylus tip comprised of a flexible elastomer, the flexible elastomer including alternating layers of a conductive material and an insulating material, wherein deforming the flexible elastomer causes a change in capacitance between the layers of the conductive material; and
a capacitance detection circuit coupled to the conductive material in the capacitive stylus tip for measuring a change in capacitance when the flexible elastomer is deformed.

2. The system as defined in claim 1 wherein the system further comprises disposing the capacitance detection circuit in the stylus body.

3. The system as defined in claim 1 wherein the system further comprises disposing the capacitance detection circuit in a touch sensor coupled to the stylus body.

4. The system as defined in claim 1 wherein the capacitive stylus tip is selected from the groups of shapes comprised of a cone and a rectangular block.

5. A system for detecting a magnitude of pressure on a capacitive stylus tip, said system comprised of:
a stylus body;
a capacitive stylus tip coupled to a working end of the stylus body, the capacitive stylus tip comprised of a flexible elastomer;
a conductive element partially disposed within an attaching end of the capacitive stylus tip, and extending from the attaching end and partially into the working end of the stylus body, wherein the stylus body provides a cavity in which a free end of the conductive element is able to bend toward the inner wall of the stylus body when the capacitive stylus tip is deformed by pressure applied to a working end thereof;
a plurality of capacitance sensing electrodes disposed on an inner wall of the stylus body for detecting a position of the conductive element within the stylus body.

6. The system as defined in claim 5 wherein the system further comprises the conductive element not extending out of a working end of the capacitive stylus tip.

7. The system as defined in claim 5 wherein the system further comprises a cavity disposed in the attaching end of the capacitive stylus tip to thereby enable the conductive element to be deflected a greater distance within the stylus body.

8. The system as defined in claim 5 wherein the system further comprises a capacitance detection circuit coupled to each of the plurality of capacitance sensing electrodes, the capacitance detection circuit disposed in the stylus body.

9. The system as defined in claim 5 wherein the system further comprises a capacitance detection circuit coupled to each of the plurality of capacitance sensing electrodes, the capacitance detection circuit disposed in a touch sensor coupled to the stylus body.

10. A system for detecting a magnitude of pressure on a capacitive stylus tip, said system comprised of:
a stylus body;
a capacitive stylus tip coupled to a working end of the stylus body, the capacitive stylus tip comprised of a flexible elastomer;
a conductive element partially disposed within an attaching end of the capacitive stylus tip, and extending from the attaching end and partially into the working end of the stylus body, wherein the stylus body provides a cavity in which a free end of the conductive element is able to bend toward the inner wall of the stylus body when the capacitive stylus tip is deformed by pressure applied to a working end thereof;
a proximity sensitive capacitive sensor disposed adjacent to the free end of the conductive element, the proximity sensitive capacitive sensor being disposed perpendicular to a long axis of the conductive element for detecting a position of the conductive element within the stylus body.

11. The system as defined in claim 10 wherein the system further comprises the conductive element not extending out of a working end of the capacitive stylus tip.

12. The system as defined in claim 10 wherein the system further comprises a cavity disposed in the attaching end of the capacitive stylus tip to thereby enable the conductive element to be deflected a greater distance within the stylus body.

13. The system as defined in claim 10 wherein the system further comprises a conductive button disposed on the free end of the conductive element to thereby increase a capacitive signal of the conductive element.
